(19) United States
(12) Patent Application Publication
(10) Pub. No.: US 2008/0276677 A1
(43) Pub. Date: Nov. 13, 2008

(54) System and method for carbon dioxide double sequestration

(75) Inventor: Hsiao-Yuan Li, Richardson, TX (US)

Correspondence Address: Hsiao-Yuan Li, Suite B2, 100 S. Bowser Road, Richardson, TX, 75081, US

(73) Assignee: 21-Century Silicon, Inc.

(21) Appl. No.: 11/801,619

(22) Filed: May 10, 2007

(51) Int. Cl. F01N 3/00; C05D 9/00

(52) U.S. Cl. 71/31; 422/168

(57) ABSTRACT

A climate control system capable to absorb many times the human-industrial-generated carbon dioxide and reverse the trend of global warming is described in this invention. Method of partially executing Solvay soda ash process without converting sodium bicarbonate to soda ash and recycling ammonia, further thereafter implementing ammonium chloride thus obtained as deep-water ocean fertilizer to capture carbon dioxide naturally in weights of the order of hundred times that was originally released through fossil fuel combustion.

### FIELD OF INVENTION

The present invention lies in the field of climate control technology, and more specifically, by adapting (1), Solvay process to absorb carbon dioxide from fossil fuel combustion; and (2), without regenerating ammonia from ammonium chloride of said Solvay process, and using the ammonium chloride so obtained as aqua marine fertilizer for massive reduction of carbon dioxide already in the atmosphere, to an extent of producing biomass hundreds times the weight of ammonium chloride.

### BACKGROUND OF THE INVENTION

United State burns annually close to one billion tons of coal for power generation. China and India burn nearly the same amount and may soon surpass United States. Expert reports stated that severe consequence on human society may result if greenhouse effect is left uncontrolled or improperly controlled. United States Department of Energy has demonstration projects that are capable to absorb better than 99 percent of carbon dioxide by scrubbing the flue gas with low molecular weight amines. The amines are regenerated for reuse and carbon dioxide sequestrated by storing underground or used for enhancing crude oil production. However, none of the existing carbon dioxide sequestration systems and methods has large enough extent to reverse the carbon dioxide produced by human beings before the disaster strikes.

Ernest Solvay invented the ammonia-soda process circa 1860's that bears his name. The reaction is carried out by passing concentrated brine through two scrubbing towers. In the first, ammonia bubbles up through the brine and is absorbed by it. In the second, carbon dioxide bubbles up through the ammoniated brine, and sodium bicarbonate precipitates out of the solution

The worldwide production of soda ash in 2005 has been estimated at 41.9 million metric tons. Solvay-based chemical plants now produce roughly three-fourth of this supply, with the remainder being mined from natural deposits.

The Solvay process as it is practiced today, discharges carbon dioxide into the atmosphere via (1) converting sodium bicarbonate into soda ash, (2), producing quicklime from fossil fired kiln for recovering ammonia from ammonium chloride, and (3), using natural gas based hydrogen to produce ammonia by Haber Bosch Process.

### SUMMARY OF THE INVENTION

The carbon dioxide sources cited in the last paragraph can be avoided if (a), sodium bicarbonate (very huge quantity) is shipped back and buried in coal pit, (b), ammonium chloride, without regeneration, is shipped ocean bound and used as aqua marine fertilizer, and (c), hydrogen from water electrolysis using photovoltaic solar electricity.

Steps (a) and (b) can be achieved today. Step (c) will be a reality several decades from now.

This comprises the method of carbon dioxide double-sequestration of this invention.

By molecular weight comparison, based on one billion tones of coal (carbon) per year, 3.67 billion tones of carbon dioxide is sequestrated in 7.0 billion tons of sodium bicarbonate that consumes 1.417 billion tons of ammonia, and produces 4.46 billion tons of ammonium chloride fertilizer byproduct, potentially producing greater than 400 billion tons of dry carbon hydrate biomass with carbon content greater than 160 billion tons.

This comprises the carbon dioxide double-sequestration system of this invention.

### DETAILED DESCRIPTION OF THE PREFERRED EMBODIMENTS

It is well known to seamen before Christopher Columbus discovery of America that marine aqua culture grow only in shallow sea water along the shore line. Consequently, the majority of the ocean surface is not engaged in carbon dioxide uptake. The most preferred embodiment of a natural carbon dioxide sequestration system is to enlist large area of lightly vegetation-populated deep ocean surface and cultivate it with ammonium chloride fertilizer and other trace nutrients.

Said preferred embodiment is comprised of a first and direct sequestration process, wherein two scrubbers are connected in sequence; and a second and natural sequestration process, wherein deep water ocean agriculture cultivation is practiced. In the first scrubber, saturated brine of sodium chloride solution is counter flown downwardly from the top against ammonia gas flowing upwardly. In the second scrubber, ammonia brine from first scrubber is counter flown downwardly from the top against after-combustion flue gas flowing upwardly. The chemical reaction occurring in the second scrubber is NaCl+NH.sub.3+H.sub.2O+CO.sub.2.fwdarw.NaHCO.sub.3+NH.sub.4Cl.

Said sodium bicarbonate, being slightly soluble in aqueous ammonium chloride solution, is allow to separate by a separation means. Said sodium bicarbonate solids is shipping return-bound with the empty coal train and buried in coalmine pits for future use. Said ammonium chloride solution is shipping ocean-bound for deep water aqua marine vegetation growth.

Said second sequestration process is comprised of a nitrogen fertilizer composed of essentially of ammonium chloride blended with a trace amount of nutrients suitable for a particular spices of aqua marine algae.

What is claimed is:

1. A system that can reduce the amount of carbon dioxide in atmosphere in huge quantity comparable to what human produced from combustion of fossil fuels, comprising:
i), a direct sequestration subsystem consisting of an aqueous solution of sodium chloride and ammonia capable of scrubbing off carbon dioxide from post-combustion gas and separate it into sodium bicarbonate solid and concentrated aqueous solution of ammonium chloride;
ii). a transportation means to ship
(a), said sodium bicarbonate solid to a proper storage location for long term storage, preferably the original coal mine pit, and
(b), said aqueous solution of ammonium chloride to deep-water ocean area and spread said solution to a very large acreage; and
iii), a second sequestration subsystem to naturally absorb atmospheric carbon dioxide via surface of said large acreage of deep-water ocean by the growth of aqua marine vegetation employing said ammonium chloride as fertilizer to stimulate photosynthesis process of converting carbon dioxide into carbon hydrate compounds.

2. An method of sequestration carbon dioxide into sodium bicarbonate solid for permanent storage consisting of:
i), absorbing carbon dioxide containing gas in a saturated brine solution further saturated with ammonia;
ii), separating the solution phase of ammonia chloride from sodium bicarbonate precipitation by a separation means; and
iii), said solution phase of ammonium chloride for carbon-dioxide second-sequestration usage as ocean-bound fertilizer to stimulate aqua marine vegetation growth in less populated deep-water ocean area for massive reduction of carbon dioxide already existing in earth atmosphere.
